(19) United States
(12) Patent Application Publication
(10) Pub. No.: US 2026/0184974 A1
(43) Pub. Date: Jul. 2, 2026

(54) COLOR STABLE EPOXY COMPOSITIONS WITH LONG POT LIFE

(71) Applicant: 3M INNOVATIVE PROPERTIES COMPANY, St. Paul, MN (US)

(72) Inventor: Yangbin Chen, Lake Elmo, MN (US)

(21) Appl. No.: 18/868,256

(22) PCT Filed: May 23, 2023
(86) PCT No.: PCT/IB2023/055294

§ 371 Date: Nov. 22, 2024

Related U.S. Application Data
(60) Provisional application No. 63/347,907, filed on Jun. 1, 2022.

(51) Int. Cl. C09J 163/00; C08G 59/22; C08G 59/42; C08K 3/36; C09J 5/00; C09J 11/04

(52) U.S. Cl. CPC C09J 163/00; C08G 59/22; C08G 59/4238; C09J 5/00; C09J 11/04; C08K 3/36; C09J 2463/00

(57) ABSTRACT

Curable compositions are described. In particular, curable compositions including non-aromatic epoxy resin, non-aromatic anhydride-based curing agents, colorant, and a solid nitrogen-containing catalyst are described. Such curable compositions may exhibit long useful pot life when stored at room temperature.

### FIELD

The present description relates to color stable epoxy compositions with a long pot life and articles containing such compositions.

### BACKGROUND

Epoxy-based materials have high adhesion and good durability for bonding to materials such as metals, glass, ceramics, and plastics. Conventional epoxy-based materials are not color stable, in that they yellow or darken significantly when exposed to heat, UV radiation, or chemicals.

### SUMMARY

In one aspect, the present description relates to a curable composition. The curable composition includes a non-aromatic epoxy resin, a non-aromatic anhydride-based curing agent, a colorant, and a nitrogen-containing catalyst, wherein the nitrogen-containing catalyst is solid at temperatures below 25° C.

In another aspect, the present description provides a method of using a curable composition. The method includes providing a curable composition including a non-aromatic epoxy resin, a non-aromatic anhydride-based curing agent, a colorant, and a nitrogen-containing catalyst, when the nitrogen-containing catalyst is solid at temperatures below 25° C. The method further includes storing the curable composition at a temperature between 20° C.-25° C. for at least 1 day, dispensing the curable composition on a substrate, and optionally curing the curable composition.

The above summary of the present description is not intended to describe each embodiment of the present invention. The details of one or more embodiments of the invention are also set forth in the description below. Other features, objects, and advantages of the invention will be apparent from the description and from the claims.

### DETAILED DESCRIPTION

The terms “aliphatic” and “cycloaliphatic” as used herein refer to compounds with hydrocarbon groups that are alkyl or alkylene groups.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof. The alkylene often has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

The term “aromatic” as used herein refers to compounds with hydrocarbon groups that are aryl or arylene groups.

The term “non-aromatic” as used herein refers to compounds that do not include aryl or arylene groups.

The term “aryl” refers to a monovalent group that is aromatic and carbocyclic. The aryl can have one to five rings that are connected to or fused to the aromatic ring. The other ring structures can be aromatic, non-aromatic, or combinations thereof. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The term “arylene” refers to a divalent group that is carbocyclic and aromatic. The group has one to five rings that are connected, fused, or combinations thereof. The other rings can be aromatic, non-aromatic, or combinations thereof. In some embodiments, the arylene group has up to 5 rings, up to 4 rings, up to 3 rings, up to 2 rings, or one aromatic ring. For example, the arylene group can be phenylene.

It may be desirable in many applications to have a one-part curable composition that does not require components to be stored separately and mixed at or near the time of dispensing. It may further be desirable for such a one-part curable composition to be stable at room temperature (e.g., without hardening or increasing in viscosity so much that it become difficult or impossible to dispense) for an extended period: in some cases at least one day, in some cases at least seven days, in some cases at least ten days, or in some cases at least twenty days. With comparable performance, stability for as long as possible is desirable in many applications. This stability may be referred to with pot life: a measure of the effective usable/dispensable lifespan, when stored at room temperature, of the curable composition.

In some embodiments, the present description relates to a curable composition that includes a non-aromatic epoxy resin, a non-aromatic anhydride-based curing agent, a colorant, and a nitrogen-containing catalyst, wherein the nitrogen-containing catalyst is solid at temperatures below 25° C. The curable composition may also comprise an array of optional additives. Generally, the curable compositions, upon curing, have strong adhesive properties and are color stable even upon exposure to harsh conditions (e.g., chemicals exposure, heat exposure, UV aging).

In some embodiments, the curable composition may include at least one non-aromatic epoxy resin. Suitable non-aromatic epoxy resins include diglycidyl ether based epoxy resins and alicyclic epoxy resins such as diepoxy acetals, diepoxy adipates, diepoxy carboxylates, and dicyclopentadiene-based epoxy resins; isocyanurate derivative epoxy resins such as triglycidyl isocyanurate; and hydrogenated epoxy resins prepared by hydrogenating the aromatic ring(s) within aromatic epoxy resins such as bisphenol A epoxy resins, bisphenol F epoxy resins, phenol novolak epoxy resins, cresol novolak epoxy resins, naphthalene epoxy resins, biphenyl epoxy resins, aralkyl epoxy resins and biphenylaralkyl epoxy resins. Two or more of these resins may also be used in combination.

In some embodiments, the non-aromatic epoxy resins may be no color or low color and/or transparent resins. In this manner, the color of the curable compositions of the present description may be established by the colorants included in the compositions.

In some embodiments, the non-aromatic epoxy resin is a liquid epoxy resin at room temperature. In some embodiments, the non-aromatic aromatic epoxy resin is the majority reactive component of the curable composition. In some embodiments, the curable composition comprises 50-95 or 60-90 parts by weight of non-aromatic epoxy resin per 100 parts total weight of reactive components.

In some embodiments, the curable composition also comprises one or more anhydride-based curing agents. As used herein, an “anhydride-based curing agent” refers to a compound formed by dehydrating a dicarboxylic acid according to structural formula (I), where A is an aliphatic or cycloaliphatic linking group.

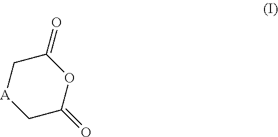

Examples of suitable anhydride-based curing agents include: linear polymeric anhydrides such as polysebacic and polyazelaic anhydride; alicyclic anhydrides such as methyltetrahydrophthalic anhydride, tetrahydro phthalic anhydride, methyl nadic anhydride, hexahydrophthalic anhydride, and methylhexahydrophthalic anhydride; simple alicylic anhydrides such as succinic anhydride, substituted succinic anhydride, citric acid anhydride, maleic anhydride and special adducts of maleic anhydride, dodecyl succinic anhydride, maleic anhydride, or multi-ring alicyclic anhydrides. In some embodiments, a combination of two or more anhydride-based curing agents may be used; for example, a combination of tetrahydro phthalic anhydride and citric acid anhydride, a combination of methylhexahydrophthalic anhydride and dodecyl succinic anhydride, or a combination of methyl nadic anhydride and maleic anhydride.

In some embodiments, the curable compositions comprise 10-45, 10-30, or 12-25 parts by weight of anhydride-based curing agent per 100 parts total weight of reactive components. In some embodiments, the curing agent consist of, or consists essentially of, anhydride-based curing agents.

In some embodiments, alternatively, the curing agents may include one or more amine-based curing agents. In some embodiments, the amine-based curing agents may be non-aromatic. Examples of suitable amine-based curing agents include: liquid polyetheramines such as the commercially available JEFFAMINE T-403 and JEFFAMINE D-230 from Huntsman Corp.; 4,7,10-Trioxatridecane-1,13-diamine, and 4,9-Dioxadodecane-1,12-diamine; polyamidoamines such as VERSAMID 125 and GENAMID 490 commercially available from BASF; ethyleneamines such as DETA (diethylene triamine), TETA (triethylenetetramine), TEPA (tetraethylenepentamine), and AEP (N-aminoethylpiperazine); cycloaliphatics such as PACM (bis-(p-aminocyclohexyl) methane), DACH (diaminocyclohexane), and DMCH (bis-(dimethyldi-aminocyclohexyl) methane); isophorone diamine, and norbornene dimethylamine.

In some embodiments, the curing agents may include no-color or low-color and/or transparent curing agents. In this manner, the color of the curable compositions of the present description may be established by the addition of one or more colorants to the compositions.

In some embodiments, the curing agent is a liquid at room temperature.

In some embodiments, the curable compositions comprise 10-35, 10-20, or 12-18 parts by weight of amine-based curing agent per 100 parts total weight of reactive components.

In some embodiments, the curable compositions of the present description may include one more colorants (or dyes or pigments). As used herein, the term “colorants” refers to a substance that is added to the composition for purposes of imparting color and/or other opacity to the compositions—the term “colorant” does not encompass the reactive components or any other materials added to the curable compositions to effect cure. For example, one or more colorants may be present in the curable composition such that the cured curable composition “color matches” the color of a component to which the cured composition will be adjacent (e.g., an external/user visible component of an electronic device). Various types of colorants may be suitable for the curable compositions including commercially available dyes for the azo (e.g, Oil Red O) and anthraquinone (e.g., Solvent Blue 35) family of colorants. In some embodiments, suitable colorants may include organic dyes such as azo, anthraquinoe, phthalocyanine blue and green, quinacridone, dioxazine, isoindolinone, or vat dyes. In some embodiments, the colorants include copper phthalocyanine (blue and green), azo, diarylide, quidacridone, isoindoline, diketo-pyrrole, indanthrone, carbon blacks, iron oxides, or titanium dioxides.

In some embodiments, the colorant may be dispersed or otherwise disposed in the curable compositions (as well as the cured compositions) such that the compositions have a uniform or substantially uniform color throughout their composition at a wide range of operating temperatures (e.g., between-40 and 85 degrees Celsius). In some embodiments, the colorant may be stable in the curable compositions (i.e., (i) non-reactive or substantially non-reactive with or not consumed by the components of the curable composition; and (ii) remain uniformly or substantially uniformly dispersed or otherwise disposed, in the working fluid at a wide range of operating temperatures over extended periods).

In some embodiments, colorants may be present in the curable compositions in an amount of between 0.1 and 10 wt. % or between 0.1 and 5 wt. %, based on the total weight of the reactive components.

The curable composition may contain additional optional additives. These optional additives can be either solids or liquids, and reactive or unreactive. Among the suitable additives are fillers, including thermally conductive fillers, flame retardants (such as ATH (aluminum trihydrate) or phosphate flame retardants), nanoparticles or functionalized nanoparticles, chain extenders, toughening agents, or combinations thereof. These components are typically solids, but some of the additive components can be liquids, and these liquid components may be suitable.

Examples of non-reactive additives include fillers, flame retardants, nanoparticles, and toughening agents. Particularly suitable non-reactive additives are fillers such as metal oxides (silica, titania, magnesium oxide, and the like) and thermal conductivity enhancers such as boron nitride. In some embodiments, the curable compositions may be highly filled; for example, 50 weight percent of the curable composition may be a filler (such as silica or titania). In some embodiments, these fillers may be selected for their geometry and rheology. In some embodiments, these fillers may have substantially spherical shape. In some embodiments, the size and distribution of these fillers may be selected for optimal or desired flowability characteristics. In some embodiments, the fillers may have a bimodal size distribution. In some embodiments, the fillers include at least two populations of particle sizes: one larger than 3 micrometers and one smaller than 3 micrometers.

In some embodiments, additives for the curable compositions of the present description may include one or more epoxy toughening agents. Such toughening agents may be useful, for example, for improving certain properties of the compositions so that they do not undergo brittle failure in a fracture. Examples of useful toughening agents, which may also be referred to as elastomeric modifiers, include polymeric compounds having both a rubbery phase and a thermoplastic phase such as graft copolymers having a polymerized diene rubbery core and a polyacrylate or polymethacrylate shell; graft copolymers having a rubbery core with a polyacrylate or polymethacrylate shell; elastomeric particles polymerized in situ in the epoxide from free-radical polymerizable monomers and a copolymeric stabilizer; elastomer molecules such as polyurethanes and thermoplastic elastomers; separate elastomer precursor molecules; combination molecules that include epoxy-resin segments and elastomeric segments; and, mixtures of such separate and combination molecules. The combination molecules may be prepared by reacting epoxy resin materials with elastomeric segments; the reaction leaving reactive functional groups, such as unreacted epoxy groups, on the reaction product. The use of tougheners in epoxy resins is described in the Advances in Chemistry Series No. 208 entitled “Rubbery-Modified Thermoset Resins”, edited by C. K. Riew and J. K. Gillham, American Chemical Society, Washington, 1984. The amount of toughening agent to be used depends in part upon the final physical characteristics of the cured resin desired.

In some embodiments, the toughening agent in the curable compositions of the present description may include graft copolymers having a polymerized diene rubbery backbone or core to which is grafted a shell of an acrylic acid ester or methacrylic acid ester, monovinyl aromatic hydrocarbon, or a mixture thereof, such as those disclosed in U.S. Pat. No. 3,496,250 (Czerwinski). Rubbery backbones can comprise polymerized butadiene or a polymerized mixture of butadiene and styrene. Shells comprising polymerized methacrylic acid esters can be lower alkyl(C₁₋₄) methacrylates. Monovinyl aromatic hydrocarbons can be styrene, alpha-methylstyrene, vinyltoluene, vinylxylene, ethylvinylbenzene, isopropylstyrene, chlorostyrene, dichlorostyrene, and ethylchlorostyrene.

Further examples of useful toughening agents are acrylate core-shell graft copolymers wherein the core or backbone is a polyacrylate polymer having a glass transition temperature (T_{g}) below about 0° C., such as poly(butyl acrylate) or poly(isooctyl acrylate) to which is grafted a polymethacrylate polymer shell having a T_{g} about 25° C. such as poly(methyl methacrylate). For acrylic core/shell materials “core” will be understood to be acrylic polymer having T_{g}<0° C. and “shell” will be understood to be an acrylic polymer having T_{g}>25° C. Some core/shell toughening agents (e.g., including acrylic core/shell materials and methacrylate-butadiene-styrene (MBS) copolymers wherein the core is crosslinked styrene/butadiene rubber and the shell is polymethylacrylate) are commercially available, for example, from Dow Chemical Company under the trade designation “PARALOID”.

Another useful core-shell rubber is described in U.S. Pat. Appl. Publ. No. 2007/0027233 (Yamaguchi et al.). Core-shell rubber particles as described in this document include a cross-linked rubber core, in most cases being a cross-linked copolymer of butadiene, and a shell which is preferably a copolymer of styrene, methyl methacrylate, glycidyl methacrylate and optionally acrylonitrile. Specific examples are Kane Ace M731, M732, M511, MX-553, and M300 commercially available from Kaneka.

In some embodiments, the toughening agent may include an acrylic core/shell polymer; a styrene-butadiene/methacrylate core/shell polymer; a polyether polymer; a carboxyl- or amino-terminated acrylonitrile/butadiene; a carboxylated butadiene, a polyurethane, or a combination thereof.

In some embodiments, toughening agents may be present in the curable composition in an amount between 0.1 and 10 wt. %, 0.1 and 5 wt. %, 0.5 and 5 wt. %, 1 and 5 wt. %, or 1 and 3 wt. %, based on the total weight of the curable composition.

In some embodiments, the curable composition includes a catalyst. In some embodiments the catalyst is a nitrogen-containing catalyst. In some embodiments, the nitrogen-containing catalyst is solid at room temperature, or at temperatures below 25° C. In some embodiments, a solid nitrogen-containing catalyst can lead to surprisingly long pot life for single component packages of the curable composition. As the nitrogen-containing catalyst remains solid at room temperature, the pot life of such curable compositions is remarkably long, so long as the curable composition remains at room temperature. Suitable solid nitrogen-containing catalysts include FUJICURE FXR-1081 (available from T&K Toka Corporation, Saitama, Japan), Ancamine 2441 (available from Evonik Industries AG, Essen, Germany), and Ancamine 2442 (available from Evonik Industries AG, Essen, Germany). A doubling of viscosity from an initial or reference value may be a reasonable definition of pot life for many applications. In some embodiments, the viscosity of the curable composition does not increase to more than 200% of an initial viscosity after 1 day. In some embodiments, the viscosity of the curable composition does not increase to more than 200% of an initial viscosity after 3 days. In some embodiments, the viscosity of the curable composition does not increase to more than 200% of an initial viscosity after 7 days. In some embodiments, the viscosity of the curable composition does not increase to more than 200% of an initial viscosity after 10 days. In some embodiments, the viscosity of the curable composition does not increase to more than 200% of an initial viscosity after 14 days. In some embodiments, the viscosity of the curable composition does not increase to more than 200% of an initial viscosity after 20 days. In some embodiments, the viscosity of the curable composition does not increase to more than 200% of an initial viscosity after 21 days.

In some embodiments, upon curing, the curable compositions of the present description may exhibit thermal, mechanical, and rheological properties that render the compositions particularly useful as adhesives or coatings for cosmetic applications that require strong adhesion to substrates over time as well as strong adhesion to substrates upon sudden impact (i.e., strong drop performance). In some embodiments, in addition to having strong adhesion, durability, drop performance, the curable compositions of the present description may exhibit color stability in the presence of heat, UV light, and household chemicals, as well as when exposed to chemical anodization or dye infusion processes. In this regard, in some embodiments, upon exposure to an acid bath in accordance with the Anodization Bath Simulation Process set forth in the Examples of the present description, the cured compositions of the present description may exhibit a ΔE 94 color change of less than 1, less than 0.8, or less than 0.5. In some embodiments, upon exposure to an ultraviolet light in accordance with the UV exposure tests set forth in the Examples of the present description, the cured compositions of the present description may exhibit a ΔE 94 color change of less than 5, less than 3, less than 2, or less than 1.

In some embodiments, the cured compositions exhibit performance properties requisite of an adhesive suitable for use in electronic devices. In this regard, in some embodiments, the cured compositions may have an overlap shear value on an etched aluminum substrate of at least 25 MPa, at least 30 MPa, or at least 35 MPa. For purposes of the present description, overlap shear values are determined in accordance with ASTM D-1002-72. Further, the cured compositions may have a notched izod toughness value of at least 20 J/m, at least 30 J/m, or at least 40 J/m. For purposes of the present description, notched izod toughness values are determined in accordance with ASTM D-256.

In some embodiments, the cured compositions may have a tensile elongation of at least 10% and a glass transition temperature of at least 80 degrees Celsius.

Also disclosed herein are articles prepared from the curable compositions described above.

In some embodiments, the articles of the present description may be fabricated by forming the curable compositions (before, after, or during cure) into a desirable or predetermined shape. Shaping of the curable compositions (or cured compositions) may be carried out using machining, micromachining, microreplication, molding, extruding injection molding, ceramic pressing, or the like. In this manner, articles of any size or shape may be formed using the curable compositions of the present description. For example, in some embodiments, the articles of the present description may include user visible, or cosmetic, components of an electronic device (e.g., a case or housing for a mobile phone, tablet, watch, headphone, or laptop).

In further embodiments, the curable compositions may be coated onto a substrate and permitted to cure. The articles may include a substrate comprising a first major surface and a second major surface, and a coating on at least a portion of the second major surface of the substrate, where the coating comprises a cured layer of a curable composition.

The coatings can be coated on a wide range of substrates. Examples of suitable substrates include metal substrates, ceramic substrates, glass substrates, or polymeric substrates. The substrates can be in a variety of shapes such as plates or tubes, and may have smooth or irregular surfaces and may be hollow or solid.

The curable composition can be applied to a substrate to form a curable layer using a variety of techniques, including dip coating, forward and reverse roll coating, wire wound rod coating, and die coating. Die coaters include knife coaters, slot coaters, slide coaters, fluid bearing coaters, slide curtain coaters, and drop die curtain coaters. Upon coating, the curable composition is permitted to cure to form a cured coating.

The thickness of the coating varies depending upon the desired use for the coating. In some embodiments, the coatings may range from 25 micrometers (1 mil) to 1 millimeter in thickness. The curable compositions may be coated onto substrates at useful thicknesses ranging from 5 microns to 10000 microns, 25 micrometers to 10000 micrometers, 100 micrometers to 5000 micrometers, or 250 micrometers to 1000 micrometers.

In some embodiments, the curable composition may function as a structural adhesive, i.e. the curable composition is capable of bonding a first substrate to a second substrate, after curing. In some embodiments, the present description provides an article comprising a first substrate, a second substrate, and a cured composition disposed between and adhering the first substrate to the second substrate, wherein the cured composition is the reaction product of the curable composition according to any one of the curable compositions of the present description. In some embodiments, the first and/or second substrate may be at least one of a metal, a ceramic, and a polymer.

The curable compositions may be coated onto substrates at useful thicknesses ranging from 5 micrometers to 10000 micrometers, 25 micrometers to 10000 micrometers, 100 micrometers to 5000 micrometers, or 250 micrometers to 1000 micrometers. Useful substrates can be of any nature and composition, and can be inorganic or organic. Representative examples of useful substrates include ceramics, siliceous substrates including glass, metal (e.g., aluminum or steel), natural and man-made stone, woven and nonwoven articles, polymeric materials, including thermoplastic and thermosets, (such as polymethyl (meth)acrylate, polycarbonate, polystyrene, styrene copolymers, such as styrene acrylonitrile copolymers, polyesters, polyethylene terephthalate), silicones, paints (such as those based on acrylic resins), powder coatings (such as polyurethane or hybrid powder coatings), and wood; and composites of the foregoing materials.

In some embodiments, the curable compositions of the present description may be used as a cosmetic inlay for an electronic device or component of an electronic device. Generally, a cosmetic inlay refers to a component that is positioned within a gap or hole in another material, and that is positioned, sized, and shaped such that it fills (or substantially fills) the gap or hole and is flush (or substantially flush) with the material adjacent the component/inlay. In some embodiments, the curable compositions may be used a cosmetic inlay for the casing or housing or an electronic device (mobile phone, tablet, or laptop). The casing or housing may be formed of metal (e.g, aluminum).

Methods of dispensing the curable compositions are also disclosed herein. In some embodiments, a method of dispensing the curable composition may include providing a curable composition including a non-aromatic epoxy resin, a non-aromatic anhydride-based curing agent, a colorant, and a nitrogen-containing catalyst, where the nitrogen-containing catalyst is solid at temperatures below 25° C. The method may further include storing the curable composition at 20° C.-25° C. for at least 1 day, for at least 7 days, for at least 10 days, for at least 14 days, for at least 20 days, or for at least 21 days, then dispensing the curable composition on a substrate, and then optionally curing the curable composition.

### Examples

TABLE 1
Materials

| Abbreviation | Description | Source |
|---|---|---|
| YX8000D | Phenol, 4,4′-(1-methylethylidene)bis-, | Mitsubishi Chemicals, |
| | polymer with 2-(chloromethyl)oxirane, | Tokyo Japan |
| | hydrogenated obtained under the trade | |
| | designation jER YX8000D | |
| E58005 | An elastomer modified epoxy, available | Hexion Inc, Columbus, OH |
| | under the tradename Epon Resin 58005 | |
| M-731 | Methyl methacrylate, butadiene, styrene | Kaneka North America LLC, |
| | acrylic copolymer, obtained under the | Pasadena, TX, United States |
| | trade designation Kane Ace M-731 | |
| L52D | Methylhexahydrophthalic anhydride, | Lindau Chemicals, Inc., |
| | obtained under the trade designation | Columbia, SC, United States |
| | Lindride 52-D | |
| DDSA | Dodecenylsuccinic anhydride | Dixie Chemical Company, |
| | | Inc., Pasadena, TX, United |
| | | States |
| F2098 | Lauryl dimethylamine, obtained under | Kao Specialties Americas |
| | the trade designation FARMIN DM2098 | LLC, High Point, NC, United |
| | | States |
| F-1081 | A latent epoxy curing agent and curing | T&K Toka Corporation, |
| | accelerator, available under the | Saitama, Japan |
| | tradename FUJICURE FXR-1081 | |
| MA17 | 1,3-Butadiene, homopolymer, maleated, | Total Petrochemicals & |
| | available under the tradename Ricon | Refining USA, Inc, Houston, |
| | 131 MA17 | TX, United States |
| I-1035 | Thiodiethylene bis[3-(3,5-di-tert- | BASF Corporation, Florham |
| | butyl-4-hydroxyphenyl)propionate], | Park, NJ, United States |
| | available under the tradename Irganox | |
| | 1035 | |
| H21 | Pyrogenic silica, obtained under the | Wacker Chemie AG, Munich, |
| | trade designation HDK H21 | Germany |
| TiO2 | Titanium dioxide pigment, obtained under | Kronos Worldwide, Inc., |
| | the trade designation KRONOS 2160 | Dallas, Texas, United States |
| FB-5SDC | Denka fused silica spherical powder, | Denka Company Limited, |
| | obtained under the trade designation | Tokyo Japan |
| | FB-5SDC | |
| SFP-130MC | Denka fused silica spherical powder, | Denka Company Limited, |
| | obtained under the trade designation | Tokyo Japan |
| | SFP-130MC | |

### Test Methods

### Pot Life Definition and Test Method

Pot life of uncured compositions was determined by means of viscosity measurements. The viscosity of the curable epoxy resin was measured by a shear rate sweep using a Discovery HR-3 Rheometer (commercially available from TA Instruments, New Castle, DE) in the cone and plate mode of operation, and in accordance with ASTM D3795-20. The measurements were taken at 25° C. (77° F.) using a 40 millimeters (mm) diameter stainless steel cone with a cone angle of 0.03499 radians and a 60 mm plate. Two to three grams of curable resin composition were placed between the cone and plate. The cone and plate were then closed to provide a 0.051 mm gap (at the tip) filled with resin. Excess resin was scraped off the edges with a spatula. Viscosity was measured using a shear rate sweep from 0.01 to 100 Hertz and the viscosity change over time at 10 Hertz was monitored. Between measurements, the samples were stored at 23-25° C. (73-79° F.). The test was discontinued if the viscosity reached a value that was double that of the initial value measured. This time was designated as the pot life of the compositions.

### UV Exposure Tests

UV exposure tests were conducted according to ASTM D4459-21. Cured epoxy plaques in the size of 6.35 cm×6.35 cm (2.5 in×2.5 in) at 1.6 mm thickness were continuously exposed to 4500-Watt Xenon bulb, under 2.4 W/m² irradiance at 420 nm for up to 240 hours, at 35° C. and 30% relative humidity.

### Color Change Test Method

The color change of the plaques was measured as follows. Initial color was measured for each plaque using a Konica CM3700A spectrophotometer (available from Konica Minolta Sensing Americas, Inc. Ramsey, New Jersey), in reflectance specular component included (SCI) mode with a 10-degree observer angle. After a plaque was exposed to the Anodization Bath Simulation Process, the color was measured again. The difference in color before and after the acid bath exposure was calculated using the ΔE 94 calculation as designated by the International Commission on Illumination (CIE) with an 1:C ratio of 2:1 under the illuminants F02 (cool white fluorescent). A ΔE 94 color change of less than 1 is generally regarded as undetectable to the human eye.

### Preparation of Acid Baths to Simulate Anodization Process

Suitable anodization processes for electronic devices made with aluminum are described in US Patent Publication No. 2013/0270120 A1. The process steps having the greatest impact on adhesive color are de-smut and chemical polish. A de-smut bath was made using 30% nitric acid. A chemical polish bath was made using 85% phosphoric acid.

### Anodization Bath Simulation Process

The Example and Comparative Example plaques were individually immersed in the de-smut bath for 180 seconds at 25° C.; this was immediately followed by a 30 second rinse in deionized water. Next, the plaques were immersed for 180 seconds in the chemical polish bath which had been pre-heated to 80° C. This was followed by rinsing in deionized water for 60 seconds. The plaques were then allowed to dry at ambient conditions before final color measurement.

### Overlap Shear (OLS) Test

OLS values are measured in accordance with ASTM D-1002-72. Sample adhesive composition was applied directly onto an untreated 2.5 cm×10 cm×0.3 cm (1 inch×4 inch×0.125 inch) test panel and an untreated second test panel was immediately placed against the sample adhesive composition on the first test panel so that the overlapped area was 1.3 cm×2.5 cm (0.5 inch×1 inch). A clamp was applied to the overlapped area. The test panels were aluminum. A small amount of sample adhesive composition squeezed out of the overlapped area and was allowed to remain. The bonds were allowed to cure for 1 hour at 120° C. The clamps were then removed, and the overlap bonds were tested in shear (OLS) on a tensile tester at a crosshead speed of 0.25 cm/minute (0.1 inch/minute). The overlap shear values were recorded in pounds per square inch and were converted into megaPascals (MPa). Overlap shear values represent the average value of three replicates.

### Tensile Modulus Test

Tensile Modulus was measured in accordance with ASTM D638-14 on three sample adhesive compositions taken from molded Type IV dogbones with a thickness of about 3.0 mm.

### Elongation at Break Test

Elongation at break percentage values were measured in accordance with ASTM D638-14 with a pulling rate of 5 mm/minute.

### Glass Transition Temperature T_{g}

Tg values are determined by Differential Scanning calorimetry (DSC) at a scan rate of 10° C./minute, in accordance with ASTM E1356-08.

### Sample Preparation EX1-3 (General Mixing Procedure to Prepare Curable Composition)

Using the compositions summarized in Table 2, YX8000D, L52D, DDSA. E58005, MA17, and TiO2 were weighed into plastic cups that varied in size depending on the batch size. The materials were mixed at room temperature in a DAC 600 FVZ SPEEDMIXER (FlackTek Incorporated, Landrum, S. C.) for six minutes at 1800 rpm. H21 was then added into the mixture and mixed at room temperature for 3 minutes at 2000 rpm. The mixture was cooled to room temperature before adding F-1081. F-1081 was then added and mixed at approximately 1800 rpm for 2 minutes, and then degassed using a DAC 600.2 VAC-P SPEEDMIXER (FlackTek Incorporated, Landrum, S. C.) under 30 Torr vacuum for 3 minutes at 800 rpm, to prepare the adhesive component.

Examples of the color stable epoxy adhesive compositions are listed in Table 2.

TABLE 2
Adhesive compositions of comparative example (CE) CE1 and examples (EX) EX1-3.
All the quantities in Table 2 are in wt % mass.

| | YX8000D | L52D | DDSA | M-731 | E58005 | MA17 | F2098 | F-1081 | TiO2 | H21 | I-1035 |
|---|---|---|---|---|---|---|---|---|---|---|---|
| EX1 | 25 | 17.5 | 21 | — | 23 | — | — | 4.5 | 6 | 3 | — |
| EX2 | 25 | 19 | 14 | — | 23 | 5.5 | — | 4.5 | 6 | 3 | — |
| EX3 | 25 | 17.5 | 20 | — | 23 | — | — | 4.5 | 6 | 3 | 1 |
| CE1 | 40.5 | 17.5 | 15.5 | 17 | — | — | 0.5 | — | 6 | 3 | — |

Viscosity of freshly prepared epoxy and their pot life are summarized in Table 3. Viscosity of freshly prepared epoxy means viscosity was measured within 5 minutes after all compositions were mixed.

TABLE 3
Viscosity test results

| | | | | Time to double viscosity | |
|---|---|---|---|---|---|
| | Viscosity (Pa · s) | | | at 10 Hertz | |
| | 0.1 Hz | 1.0 Hz | 10.0 Hz | (Pot life at 23-25° C.) | |
| EX1 | 282.0 | 50.1 | 14.4 | 24 | days |
| EX2 | 237.0 | 58.3 | 23.2 | 20 | days |
| EX3 | 223.7 | 52.1 | 21.0 | 24 | days |
| CE1 | 270.6 | 65.8 | 26.6 | 8 | hours |

The elongation at break, tensile modulus, OLS, and Tg properties of the color stable epoxy are summarized in Table 4.

TABLE 4
Adhesive properties

| | Elongation | Tensile | OLS | Tg |
|---|---|---|---|---|
| | at Break (%) | Modulus (GPa) | (MPa) | (° C.) |
| EX1 | 14.2 | 2.23 | 26.8 | 73 |
| EX2 | 18.0 | 1.97 | 24.9 | 72 |
| EX3 | 12.5 | 2.00 | 26.6 | 76 |
| CE1 | 4.7 | 1.75 | 20.9 | 97 |

Color measurements are identified in Table 5.

TABLE 5
ΔE 94 Color change after anodization treatment

| | | ΔE 94 after |
|---|---|---|
| | ΔE 94 after | 240-hour |
| | anodization | UV exposure |
| EX1 | 0.24 | 3.82 |
| EX2 | 0.45 | 3.60 |
| EX3 | 0.16 | 2.26 |
| CE1 | 0.10 | 1.68 |

### Sample Preparation EX4

YX8000D, L52D, and DDSA were weighted into DAC Speedmixer cups. YX8000D, L52D, and DDSA were then mixed using a DAC Speedmixer at approximately 2000 rpm for 2 minutes. SFP-130MC was then added and mixed at approximately 2000 rpm for 6 minutes. FB-5SDC was then added and mixed at approximately 2000 rpm for 6 minutes. The mixture was cooled to room temperature before adding the F-1081. F-1081 was then added and mixed at approximately 1800 rpm for 2 minutes. The obtained mixture was then degassed using vacuum DAC Speedmixer under 3 torr vacuum at approximately 800 rpm for 5 minutes.

TABLE 6
Adhesive compositions of EX4.
All the quantities in Table 6 are in wt % mass..

| | YX8000D | FB-5SDC | SFP-130MC | L52D | DDSA | F-1081 |
|---|---|---|---|---|---|---|
| EX4 | 11.94 | 59.70 | 14.93 | 7.96 | 3.98 | 1.49 |

Viscosity was measured according to ASTM D3795-20. Glass Transition Temperature (T_{g}) is measured according to ASTM E1356-08. CTE was measured according to ASTM E831. All CTE samples were cured at 130° C. for 1 hour. The test results are summarized in Table 7.

TABLE 7
Properties of adhesive compositions

| | Viscosity (25° C. | | |
|---|---|---|---|
| | at 10/s shear rate) | Tg | CTE α1 |
| | (Pa · s) | (° C.) | (ppm/° C.) |
| EX4 | 44.06 | 91 | 18.3 |

Various modifications and alterations of this invention will become apparent to those skilled in the art without departing from the scope and spirit of this invention.

1. A curable composition, comprising:
a non-aromatic epoxy resin;
a non-aromatic anhydride-based curing agent;
a colorant; and
a nitrogen-containing catalyst, wherein the nitrogen-containing catalyst is solid at temperatures below 25° C.

2. The curable composition of claim 1, wherein the curable composition includes 10-45 parts by weight of anhydride-based curing agent per 100 parts total weight of reactive components.

3. The curable composition of claim 1, wherein the non-aromatic anhydride-based curing agent comprises an aliphatic or cycloaliphatic moiety.

4. The curable composition of claim 1, wherein the curable composition includes 50-95 parts by weight of non-aromatic epoxy resin per 100 parts total weight of reactive components.

5. The curable composition of claim 1, wherein the colorant is present in the curable compositions in an amount of between 0.1 and 10 wt. %, based on the total weight of the reactive components.

6. (canceled)

7. (canceled)

8. The curable composition of claim 1, wherein the curable composition has an initial viscosity, and after exposure to 25° C. for 7 days, a measured viscosity of the curable composition is less than 200% the initial viscosity.

9. (canceled)

10. The curable composition of claim 1, wherein the curable composition has an initial viscosity, and after exposure to 25° C. for 20 days, a measured viscosity of the curable composition is less than 200% the initial viscosity.

11. (canceled)

12. The curable composition of claim 1, wherein the curable composition further comprises an epoxy terminated elastomer.

13. The curable composition of claim 1, wherein the curable composition has a T_{g} of at least 60° C.

14. The curable composition of claim 1, further comprising between 1-10 parts by weight of a maleated rubber per 100 parts total weight of reactive components.

15. The curable composition of claim 1, wherein the curable composition exhibits anodization color stability, wherein exhibiting anodization color stability means that the curable composition, once cured, has a ΔE94 color change of 0.5 or less after anodization.

16. The curable composition of claim 1, wherein the curable composition exhibits UV color stability, wherein exhibiting UV color stability means that the curable composition, once cured, has a ΔE94 color change of 4.0 of less after a 240-hour UV exposure.

17. The curable composition of claim 1, wherein the curable composition permanently adheres to aluminum.

18. The curable composition of claim 1, wherein the curable composition exhibits at least 10% elongation at break.

19. The curable composition of claim 1, wherein the curable composition includes at least 50 weight percent silica filler.

20. (canceled)

21. The curable composition of claim 15, wherein the silica filler has a bimodal size distribution.

22. The curable composition of claim 1, wherein the curable composition includes at least two different non-aromatic anhydride-based curing agents.

23. An article comprising a cured composition, wherein the cured composition is the reaction product of the curable composition according to claim 1.

24. A method of using a curable composition, comprising:
providing a curable composition comprising a non-aromatic epoxy resin, a non-aromatic anhydride-based curing agent, a colorant, and a nitrogen-containing catalyst, wherein the nitrogen-containing catalyst is solid at temperatures below 25° C.;
storing the curable composition at a temperature between 20° C.-25° C. for at least 1 day;
dispensing the curable composition on a substrate; and
optionally curing the curable composition.

25. The method of claim 19, wherein storing the curable composition at a temperature between 20° C.-25° C. is for at least 7 days.
